(19) United States
(12) Patent Application Publication
(10) Pub. No.: US 2003/0035700 A1
(43) Pub. Date: Feb. 20, 2003

(54) Anti-loosening nail exclusively for wood

(76) Inventor: Chi-Cheng Chiang, Kaohsiung Shien (TW)

Correspondence Address: Chi-Cheng Chiang, P.O. Box 90, Tainan City, 704, TW

(21) Appl. No.: 09/931,744

(22) Filed: Aug. 20, 2001

(51) Int. Cl. F16B 39/34

(52) U.S. Cl. 411/303

(57) ABSTRACT

An anti-loosening nail exclusively for wood includes an annular fix plate, a recess formed on an upper surface of the annular fix plate, and a hollow post extending down from the center section of the fix plate. The recess communicates with the center hole of the hollow post, and a washer is placed in the recess. When a screw is inserted in the center hole of the post, it screws with female threads formed in an upper portion of the center hole, and further engages with the washer to prevent the screw from loosen off of itself.

### BACKGROUND OF THE INVENTION

1. Filed of the Invention

This invention relates to an anti-loosening nail exclusively for wood, particularly to one having an annular fix plate, and a hollow post extending down from the center section of the annular fix plate, a recess provided on a top surface of the annular fix plate and communicating with the center hole of the hollow post, and a washer fitted in the recess, so engagement of the washer with a screw can prevent the screw from loosening off the anti-loosening nail of itself.

2. Description of the Prior Art

A conventional nail for connecting firmly two wood boards together generally has a threaded washer and a screw, and the threaded washer is fitted on one of the two wood boards, and the screw screws through the two wood boards to engage with the threaded washer. However, the threaded washer is apt to loosen off the screw, losing its fixing function owing to lack of a fixing member. Another kind of conventional anti-loosening nail for wood, as shown in FIG. 1, has an annular position plate 10 formed with a plurality of claws 11 spaced apart and extending downward a little curved from the annular outer edge of the position plate 10, a hollow post with a center hole 13 extending down from the center portion of the position plate 10. The center hole 13 has female threads 14 formed in an upper half portion. As shown in FIG. 2, in using this conventional anti-loosening nail, place the hollow post 12 in a hole 20 bored in a wood board 2, with the claws 11 pricking in an upper surface of the wood board 2, and a lower end of the post 12 is expanded to insert in a sidewall of the wood board 2. Then the annular position plate 10 is kept as integral with the wood board 2 by means of the claws 11 and the expanded lower end of the hollow post 12. Then the screw 3 is inserted in the hole 40 of another wood board 4 and then screws with the female threads 14 of the anti-loosening nail 1 to connect the two wood boards 2 and 4 firmly together. But the screw 3 is not kept in its place with a positioning member, possible to loosen off the anti-loosening nail 1 after a certain period of use.

### SUMMARY OF THE INVENTION

The objective of the invention is to offer an anti-loosening nail exclusively for wood. which has a feature that a recess is formed on an upper end of a center hole of a post extending down from an annular fix plate, and a washer fitted in the recess.

### BRIEF DESCRIPTION OF DRAWINGS

This invention will be better understood by referring to the accompanying drawings, wherein:

FIG. 1 is a perspective view of a conventional anti-loosening nail for wood;

FIG. 2 is a cross-sectional view of the conventional anti-loosening nail used to connect two wood boards;

FIG. 3 is an exploded perspective view of an anit-loosening nail exclusively for wood in the present invention; and,

FIG. 4 is a cross-sectional view of the anti-loosening nail exclusively for wood in a using condition in the present invention.

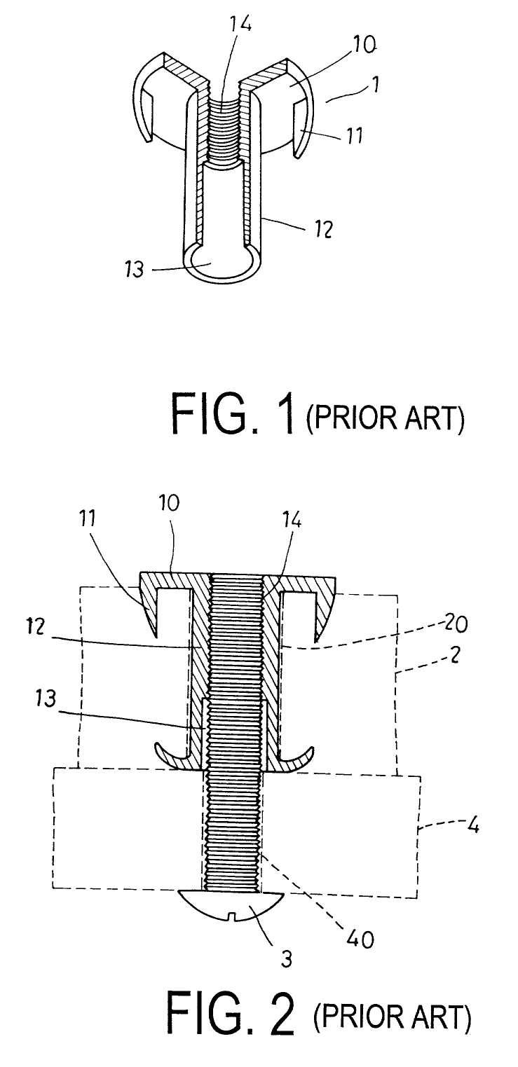

### DETAILED DESCRIPTION OF THE PREFERRED EMBODIMENT

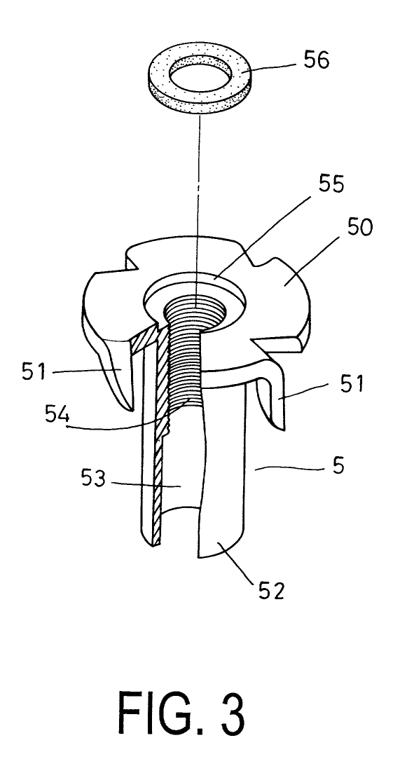

A preferred embodiment of an anti-loosening nail 5 exclusively for wood in the present invention, as shown in FIG. 3, includes an annular fix plate 50, a plurality of claws 51 spaced apart and extending down from the outer annular edge of the annular fix plate 50, and a hollow post extending down from the center portion of the annular fix plate 50. The hollow post 52 has a center hole 53 provided with female threads 54 formed in a half upper portion of the hole 53 and a recess 55 with a larger diameter than that of the center hole 53 formed in an upper end of the center hole 53. Then a washer 56 made of nylon or plastic is fitted in the recess 55.

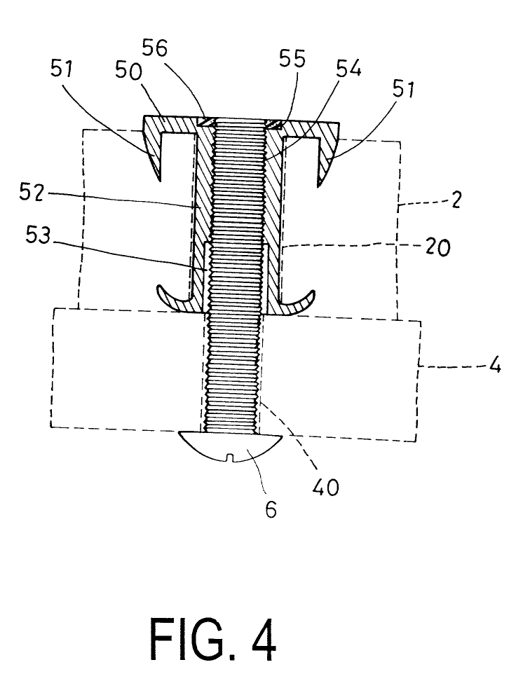

In using, referring to FIGS. 3 and 4, placed the hollow post 52 in a hole 20 of a wood board 2, and then the claws 51 are forced into a sidewall of the wood board 2. After that, the lower end of the post 52 protruding out of the lower side of the wood board 2 is expanded outward to press and insert in the lower wall of the wood board 2 as shown in FIG. 4. Then the claws 51 and the expanded lower end of the post 52 engage the two sidewalls of the wood board 2 to force the anti-loosening nail 5 and the wood board 2 become integral. Further, the screw 6 is inserted in a hole 40 of another wood board 4 and then engages the female threads 54 of the anti-loosening nail 5, with the upper end of the screw 6 also engage the washer 56 to lock the screw 6 stably. Then the two wood boards 2 and 4 are firmly connected with each other by means of the anti-loosening nail 5 and the screw 6, without fear of the anti-loosening nail loosening off the wood board of itself. And the top end of the screw 6 is not needed to glue with the wood board to be firmly positioned.

The anti-loosening nail in the present invention has the following advantages.

1. Engagement of the washer and the screw can prevent the screw from loosening off.

2. It can surely connect two wood boards firmly together.

3. The screw may not loosen off, in spite of a long term of use, nor unstable connection of two wood boards happens.

While the preferred embodiment of the invention has been described above, it will be recognized and understood that various modifications may be made therein and the appended claims are intended to cover all such modifications that may fall into the spirit and scope of the invention.

I claim:

1. An anti-loosening nail exclusively for wood comprising an annular fix plate, a plurality of claws provided spaced apart and extending a little curved down from an annular outer edge of said annular fix plate, a hollow post extending down from a center section of said annular fix plate, said hollow post having a through hole formed in a center and female threads formed in an upper half portion of said through hole; and,
characterized by said annular fix plate having a recess in an upper center section to communicate with said through hole, a washer fitted in said recess, a screw placed in said through hole and engaging said female threads and said washer in said recess, engagement of said washer and said screw preventing said screw from loosening off said anti-loosing nail.

2. The anti-loosening nail exclusively for wood as claimed in claim 1, wherein said washer is made of nylon.

3. The anti-loosening nail exclusively for wood as claimed in claim 1, said washer is made of plastic.
